(19) United States
(12) Patent Application Publication
(10) Pub. No.: US 2017/0102253 A1
(43) Pub. Date: Apr. 13, 2017

(54) ULTRASONIC DEVICE AND METHOD FOR MEASURING FLUID FLOW USING THE ULTRASONIC DEVICE

(71) Applicant: General Electric Company, Schenectady, NY (US)

(72) Inventors: Jing YE, Shanghai (CN); Christopher Edward WOLFE, Niskayuna, NY (US); Shirley Xiaolei AO, Billerica, MA (US); Ran NIU, Shanghai (CN); Weihua SHANG, Shanghai (CN); Yan MEI, Shanghai (CN)

(21) Appl. No.: 15/314,842

(22) PCT Filed: May 29, 2015
(86) PCT No.: PCT/US2015/033276

§ 371 Date: Nov. 29, 2016

(30) Foreign Application Priority Data
May 31, 2014 (CN) 201410241202.5

(51) Int. Cl. G01F 1/66; G01F 15/00

(52) U.S. Cl. CPC G01F 1/662; G01F 1/663; G01F 15/006

(57) ABSTRACT

An ultrasonic device includes a fluid conduit configured to couple with one or more pipes and an ultrasonic transducer mounted on the conduit. The conduit includes a main body defining a flow channel and a thermal barrier coupled to the main body. The thermal barrier includes an organic polymeric material and is configured to thermally isolate the ultrasonic transducer from the flow channel.

### BACKGROUND

Ultrasonic devices are widely used to measure the physical characteristics of a fluid, for example liquid and gas, flowing inside a pipe. For example, ultrasonic transducers may be used to obtain velocity information of the fluid based on ultrasonic echography and Doppler theory. Typically, an ultrasonic transducer is mounted on the pipe wall. The pulsed ultrasonic wave emitted from the ultrasonic transducer propagates to the fluid inside the pipe. Impurities and contaminations in the fluid reflect the wave and the transducer receives the echo. Doppler theory allows for velocity calculation by known formula. A velocity profile can be resulted based on the velocity information. The velocity profile is important information in studying physical fluid flow as well as in designing fluid machinery or civil engineering structure where fluid flow is involved.

The ultrasonic transducer is thermal and pressure sensitive because the high temperature and high pressure will change the properties of the transducer material and its acoustic parameters, such as impedance of the transducer. In a high temperature and high pressure environment, the performance of ultrasonic transducer may significantly decay, which may cause inaccuracy of the flow measurement with ultrasonic transducer.

Therefore, it is desired to have an ultrasonic device and method for dealing with flow measurement of high temperature and high pressure fluid.

### BRIEF DESCRIPTION

In one aspect, the present disclosure relates to an ultrasonic device. The ultrasonic device includes a fluid conduit configured to couple with one or more pipes and an ultrasonic transducer mounted on the conduit. The conduit includes a main body defining a flow channel and a thermal barrier coupled to the main body. The thermal barrier includes an organic polymeric material and is configured to thermally isolate the ultrasonic transducer from the flow channel.

In another aspect, the present disclosure relates to a method, in which a fluid is flowed in a conduit coupling with one or more pipes wherein the conduit includes a main body defining a flow channel for the fluid to flow through, and a thermal barrier including an organic polymeric material and coupled to the main body. The fluid flow is measured with an ultrasonic transducer mounted on the conduit, wherein the ultrasonic transducer is thermally isolated from the flow channel by the thermal barrier.

### BRIEF DESCRIPTION OF THE DRAWINGS

The above and other aspects, features, and advantages of the present disclosure will become more apparent in light of the subsequent detailed description when taken in conjunction with the accompanying drawing in which:

FIG. 1 is a schematic diagram illustrating an exemplary ultrasonic device.

FIG. 2 is a schematic diagram illustrating an ultrasonic device according to a specific embodiment of the present disclosure.

FIG. 3 is a schematic diagram illustrating an ultrasonic device according to a specific embodiment of the present disclosure.

FIG. 4 is a schematic diagram illustrating an ultrasonic device according to a specific embodiment of the present disclosure.

FIG. 5 is a schematic diagram illustrating an ultrasonic device according to a specific embodiment of the present disclosure.

FIG. 6 is a schematic diagram illustrating an ultrasonic device according to a specific embodiment of the present disclosure.

### DETAILED DESCRIPTION

One or more specific embodiments of the present disclosure will be described below. Unless defined otherwise, technical and scientific terms used herein have the same meaning as is commonly understood by one of ordinary skill in the art to which this invention belongs.

The terms “a” and “an” do not denote a limitation of quantity, but rather denote the presence of at least one of the referenced items. The term “or” is meant to be inclusive and mean either or all of the listed items. The use of “including,” “comprising” or “having” and variations thereof herein are meant to encompass the items listed thereafter and equivalents thereof as well as additional items. Moreover, the terms “coupled” and “connected” are not intended to distinguish between a direct or indirect coupling/connection between components. Rather, such components may be directly or indirectly coupled/connected unless otherwise indicated. Approximating language, as used herein throughout the specification and claims, may be applied to modify any quantitative representation that could permissibly vary without resulting in a change in the basic function to which it is related. Accordingly, a value modified by a term or terms, such as “about,” is not to be limited to the precise value specified. Additionally, when using an expression of “about a first value—a second value,” the about is intended to modify both values. In some instances, the approximating language may correspond to the precision of an instrument for measuring the value or values.

Embodiments of the present disclosure refer generally to an ultrasonic device which is applicable for measuring fluid flow at high temperature and high pressure environment. The ultrasonic device may be coupled to a pipe like a joint, which connects two adjoining sections of the pipe and allows a fluid from the pipe to flow through. The ultrasonic device includes a fluid conduit configured to couple with one or more pipes and at least one ultrasonic transducer mounted on the conduit. The conduit includes a main body defining a flow channel for a fluid to flow through. A thermal barrier coupled to the main body of the conduit is used to thermally isolate the ultrasonic transducer from the flow channel as well as the fluid flowing in the flow channel. The main body of the conduit typically is made from an acoustic friendly material which also has good heat insulation capability, for example, a metal material including but not limited to metals and alloys. The main body provides structural support for the conduit. The thermal barrier is made from a material which is substantially acoustic transparent and has thermal resistance higher than that of the conduit main body. In particular, the material of the thermal barrier has acoustic impedance and sonic velocity approximately equal to those of the fluid flowing in the conduit, for example within about 20% of one another, more preferably within about 10%. Such that the thermal barrier is able to separate sensors of the ultrasonic transducers from the fluid without compromising the acoustic characteristics. As such, the ultrasonic device is particularly applicable in drilling, where the fluid flow measurement may be carried out in a high temperature and high pressure environment.

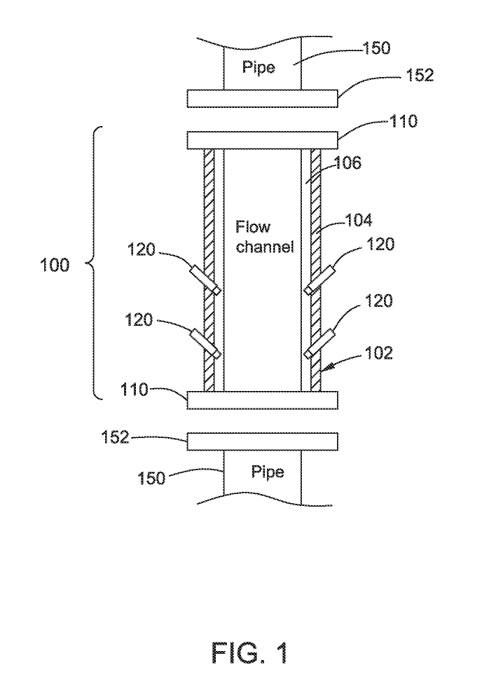

An exemplary ultrasonic device 100 is shown in FIG. 1. The ultrasonic device 100 includes a fluid conduit 102 configured to couple with one or more pipes 150. In an embodiment, the fluid conduit 102 is provided with flanges 110 at both ends thereof along the flow direction, such that the fluid conduit 102 can be coupled with one or more pipes 150 by coupling the flanges 110 with pipe flanges 152. The conduit 102 includes a main body, for example, a conduit wall 104 defining therein a flow channel. One or more ultrasonic transducers 120 are mounted on the conduit wall 104. For example, in the illustrated embodiment, four ultrasonic transducers 120 are mounted on the conduit wall 104. However, the number of the ultrasonic transducers may be changed according to the actual needs in other embodiments. As the fluid flowing in the conduit 102 may have a high temperature while the ultrasonic transducers 120 may be sensitive to the temperature, a thermal barrier 106 is coupled to the conduit wall 104 for thermally isolating the ultrasonic transducers 120 from the fluid flowing in the conduit 102. As used herein, “thermally isolating an ultrasonic transducer from a fluid” means to thermally isolate the entire ultrasonic transducer or at least a thermal sensitive part of the ultrasonic transducer from the fluid. The thermal sensitive part of the ultrasonic transducer may be a piezoelectric wafer or the like for constituting the ultrasonic transducer. The thermal barrier 106 has relatively higher thermal resistance and can effectively prevent the heat of the fluid from transferring to the ultrasonic transducers 120 mounted on the conduit wall 104 behind the thermal barrier 106. Therefore, the ultrasonic transducers 120 are thermally isolated the fluid flowing in the conduit 102.

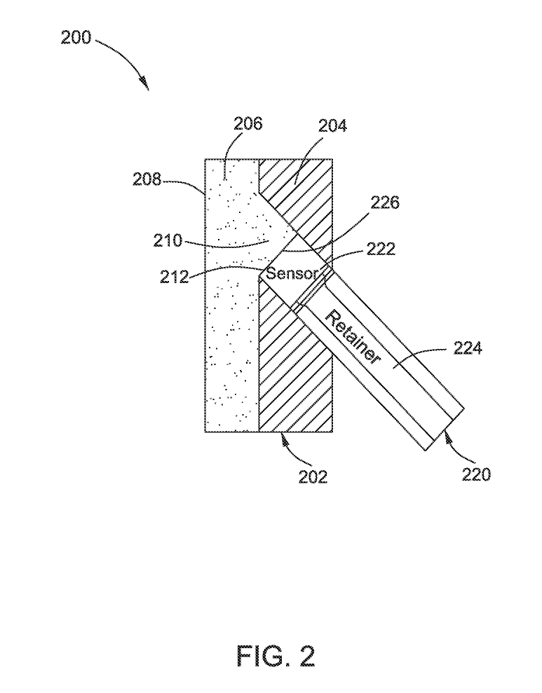

The thermal barrier may be configured in various ways. For example, the thermal barrier may include a liner (inner layer) that covers the mechanical conduit wall layer or a plug that covers the ultrasonic transducer. Some exemplary embodiments will be described hereinafter in conjunction with FIGS. 2-6.

FIG. 2 shows an embodiment of an exemplary ultrasonic device 200, in which a liner is used as the thermal barrier for thermally isolating the ultrasonic transducer from the fluid flowing in the conduit. As illustrated, a conduit 202 includes a main body, for example, a conduit wall 204 made from a metallic material, on which an ultrasonic transducer 220 is mounted. A liner 206 is coupled to an inner surface of the conduit wall 204. An inner surface 208 of the liner is provided as the internal conduit surface for facing the fluid flowing in the conduit. The fluid flowing in the conduit 202 flows on the inner surface 208 of the liner 206, and thereby is both physically and thermally isolated from the ultrasonic transducer 220. The ultrasonic transducer 220 includes a sensor 222 and a retainer 224 for retaining the sensor 222. The sensor 222 has a thermal sensitive element such as a piezoelectric wafer (not shown) installed at a front end 226 thereof. The liner 206 has a protuberance 210 protruding into the metal conduit wall 204. The protuberance 210 provides a fitting surface 212 substantially conforming to the front end 226 of the sensor 222. Air, which is a poor medium for the transmission of sound waves, can be dispelled from space between the fitting surface 212 and the front end 226 of the sensor 222 by applying an acoustic couplant between the closely fitted surfaces.

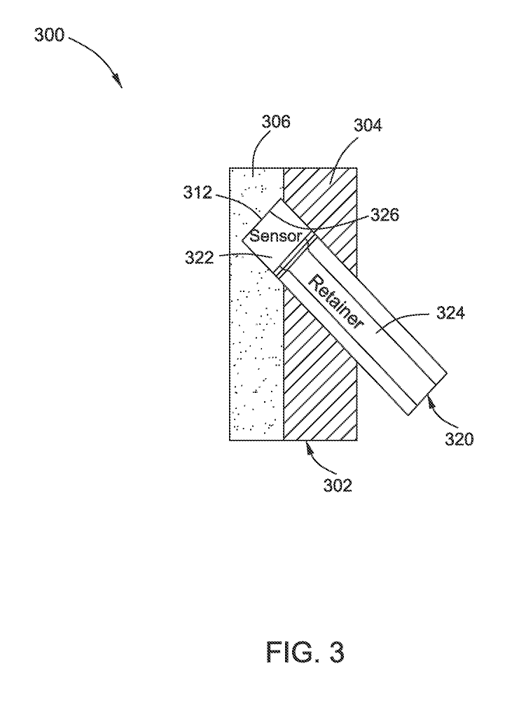

FIG. 3 shows an embodiment of an exemplary ultrasonic device 300 that is similar to the ultrasonic device 200 of FIG. 2. The difference is that, the liner 306 of the ultrasonic device 300 has a concavity for accommodating a part of the ultrasonic transducer 320 (e.g., a head portion of the sensor 322). As illustrated in FIG. 3, the ultrasonic transducer 320 has its head portion protruding from the metal conduit wall 304 into the concavity of the liner 306. Similarly, the liner 306 provides a fitting surface 312 substantially conforming to the front end 326 of the sensor 322. Air between the fitting surface 312 and the front end 326 of the sensor 322 can be dispelled by applying an acoustic couplant between the closely fitted surfaces.

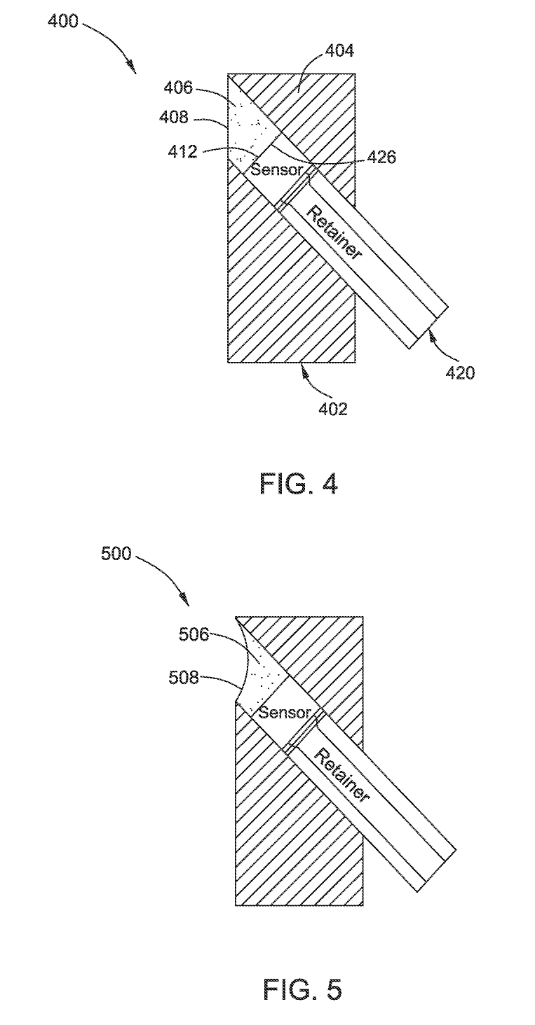

FIG. 4 shows an embodiment of an exemplary ultrasonic device 400, in which a plug is used as the thermal barrier for thermally isolating the ultrasonic transducer from the fluid flowing in the conduit. As illustrated, a conduit 402 includes a main body, for example, a conduit wall 404 made from a metallic material, on which an ultrasonic transducer 420 is mounted. A plug 406 is used to plug the cavity of the conduit wall 404 which accommodates the ultrasonic transducer 420, so as to physically and thermally isolate the ultrasonic transducer 420 from the fluid flowing in the conduit. The plug 406 provides a fluid facing surface 408 which forms a part of an internal conduit surface through which the fluid flows. The other part of the internal conduit surface is provided by the metal conduit wall 404. The plug 406 further provides a fitting surface 412 substantially conforming to a front end 426 of the ultrasonic transducer 420 where the thermal sensitive element is located. Air between the fitting surface 412 and the front end 426 of the ultrasonic transducer 420 can be dispelled by applying an acoustic couplant between the closely fitted surfaces. As such, the thermal sensitive element at the front end 426 of the ultrasonic transducer 420 is also thermally isolated from the conduit wall 404 which may be in a relatively higher temperature due to the lower heat resistance compared with the plug 406. If more than one ultrasonic transducer is used, the ultrasonic device 400 may include more than one plug, each covering the front end of one corresponding ultrasonic transducer, as described above. FIG. 5 shows an exemplary ultrasonic device 500 that is similar to the ultrasonic device 400 of FIG. 4, except the configuration of the fluid facing surface 508 provided by the plug 506. In the ultrasonic device 500, the fluid facing surface 508 is a curved surface other than a plane surface.

In the ultrasonic devices described above, as the fluid facing surface of the liner or plug forms the entire or a part of the continuous internal conduit surface for the fluid to flow through, solids contained in the fluid may be prevented from blocking the view of the sensors of the ultrasonic transducers.

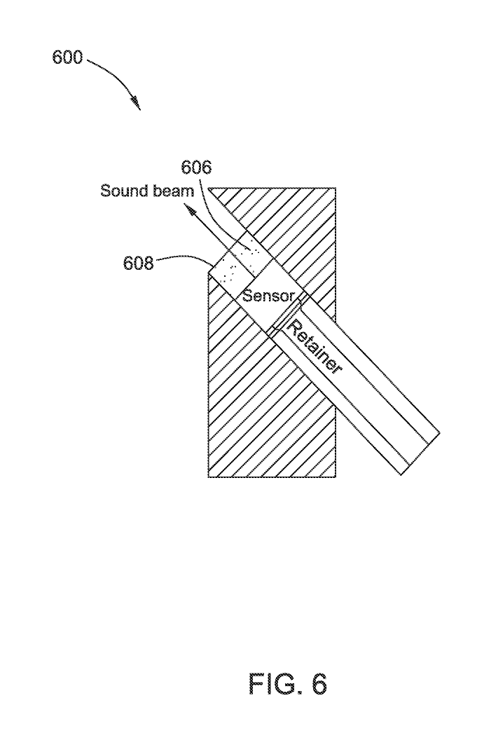

FIG. 6 shows an exemplary ultrasonic device 600 that is similar to the ultrasonic device 400 of FIG. 4, except the configuration of the fluid facing surface 608 provided by the plug 606. In the ultrasonic device 600, the fluid facing surface 608 is approximately perpendicular to sound beam of the ultrasonic transducer, such that the propagation direction of the sound beam will not change at the interface of the thermal barrier and the fluid, which can increase accuracy of the flow measurement.

In the ultrasonic device as described above, the fluid facing surface provided by the thermal barrier is configured in a manner that, a refraction angle at the fluid facing surface for sound beam of the ultrasonic transducer ranges from about 20 degrees to about 80 degrees. As such, it can be ensured that flow measurement using Doppler is accurate.

In some embodiments, the thermal barrier includes an organic polymeric material such as plastic. In particular, the organic polymeric material has a maximum service temperature higher than about 120° C., or preferably higher than about 200° C. or more preferably higher than about 250° C. As used herein, “maximum service temperature” refers to the maximum operating temperature for a material where specific properties are not unacceptably compromised after being operated continuously. Acoustic impedance of the organic polymeric material well matches with the fluid so that most of the energy from transducer can be transmitted to fluid and the reflection between the interface of the thermal barrier and the fluid is very small. For example, the thermal barrier may include plastic, which has a maximum service temperature higher than about 200° C., and in which the ultrasound wave mode is simpler and the cross-conduit signal is smaller compared to the metal conduit body. In a specific embodiment, the organic polymeric material is selected from the group consisting of polyetheretherketone (PEEK), polytetrafluoroethene (PTFE), fluorinated ethylene propylene (FEP), and combinations thereof.

The use of the thermal barrier reduces the requirement of tensile stress and heat resistance of the ultrasonic transducer, so that the ultrasonic transducer can reach better performance. In addition, the replacement of the ultrasonic transducer becomes easier in comparison with the situation without using thermal barrier to thermally isolate the ultrasonic transducer from the high temperature fluid flowing in the conduit.

Embodiments of the present disclosure also refer to a method for measuring the fluid flow with an ultrasonic device as described above. In the method, a fluid is flowed in the conduit of the ultrasonic device and the fluid flow is measured with the ultrasonic transducer which is mounted on the conduit and thermally isolated from the fluid by the thermal barrier.

The invention may be embodied in other specific forms without departing from the spirit or essential characteristics thereof. The foregoing embodiments are therefore to be considered in all respects as illustrative rather than limiting on the invention described herein. The scope of embodiments of the invention is thus indicated by the appended claims rather than by the foregoing description, and all changes that come within the meaning and range of equivalency of the claims are therefore intended to be embraced therein.

1. An ultrasonic device, comprising:
a fluid conduit configured to couple with one or more pipes and comprising a main body defining a flow channel and a thermal barrier coupled to the main body, the thermal barrier comprising an organic polymeric material; and
an ultrasonic transducer mounted on the conduit, wherein
the thermal barrier is configured to thermally isolate the ultrasonic transducer from the flow channel.

2. The ultrasonic device according to claim 1, wherein the organic polymeric material is substantially acoustic transparent and has a maximum service temperature higher than about 120° C.

3. The ultrasonic device according to claim 1, wherein the organic polymeric material is selected from the group consisting of polyetheretherketone (PEEK), polytetrafluoroethene (PTFE), fluorinated ethylene propylene (FEP), and combinations thereof.

4. The ultrasonic device according to claim 1, wherein the thermal barrier thermally isolates a thermal sensitive part of the ultrasonic transducer from the main body.

5. The ultrasonic device according to claim 1, wherein the thermal barrier has a fitting surface substantially conforming to a front end of the ultrasonic transducer where a thermal sensitive part of the ultrasonic transducer is located.

6. The ultrasonic device according to claim 5, further comprising an acoustic couplant between the fitting surface of the thermal barrier and the front end of the ultrasonic transducer.

7. The ultrasonic device according to claim 1, wherein the thermal barrier has a fluid facing surface in contact with the fluid, a refraction angle at the fluid facing surface for sound beam of the ultrasonic transducer ranging from about 20 degrees to about 80 degrees.

8. The ultrasonic device according to claim 1, wherein the thermal barrier comprises a liner coupled to an inner surface of the main body and providing an internal conduit surface through which the fluid flows.

9. The ultrasonic device according to claim 1, wherein the thermal barrier comprises a plug coupled to the main body and providing a part of an internal conduit surface through which the fluid flows, and wherein the other part of the internal conduit surface is provided by the main body.

10. The ultrasonic device according to claim 9, wherein the part of the internal conduit surface provided by the plug is approximately perpendicular to sound beam of the ultrasonic transducer.

11. A method, comprising:
flowing a fluid in a conduit coupling with one or more pipes, wherein the conduit comprises a main body defining a flow channel for the fluid to flow through, and a thermal barrier comprising an organic polymeric material and coupled to the main body; and
measuring the fluid flow with an ultrasonic transducer mounted on the conduit, wherein the ultrasonic transducer is thermally isolated from the flow channel by the thermal barrier.

12. The method according to claim 11, wherein the organic polymeric material is substantially acoustic transparent and has a maximum service temperature higher than about 120° C.

13. The method according to claim 11, wherein the organic polymeric material is selected from the group consisting of polyetheretherketone (PEEK), polytetrafluoroethene (PTFE), fluorinated ethylene propylene (FEP), and combinations thereof.

14. The method according to claim 11, wherein the thermal barrier thermally isolates a thermal sensitive part of the ultrasonic transducer from the main body.

15. The method according to claim 11, wherein the thermal barrier has a fitting surface substantially conforming to a front end of the ultrasonic transducer where a thermal sensitive part of the ultrasonic transducer is located.

16. The method according to claim 15, further comprising an acoustic couplant between the fitting surface of the thermal barrier and the front end of the ultrasonic transducer.

17. The method according to claim 11, wherein the thermal barrier has a fluid facing surface in contact with the fluid, a refraction angle at the fluid facing surface for sound beam of the ultrasonic transducer ranging from about 20 degrees to about 80 degrees.

18. The method according to claim 11, wherein the thermal barrier comprises a liner coupled to an inner surface of the main body and providing an internal conduit surface through which the fluid flows.

19. The method according to claim 11, wherein the thermal barrier comprises a plug mounted in the main body and providing a part of an internal conduit surface through which the fluid flows, and wherein the other part of the internal conduit surface is provided by the main body.

20. The method according to claim 19, wherein the part of the internal conduit surface provided by the plug is approximately perpendicular to sound beam of the ultrasonic transducer.
